(19) United States
(12) Patent Application Publication
(10) Pub. No.: US 2014/0102551 A1
(43) Pub. Date: Apr. 17, 2014

(54) EQUIPMENT COMPRISING AT LEAST ONE HYDROPNEUMATIC ACCUMULATOR WITH AUTOMATED MAINTENANCE

(71) Applicants: Thomas Hughes, Newry (IE); Alain Houssais, Andilly (FR); Laurent Granseigne, Courbevoie (FR)

(72) Inventors: Thomas Hughes, Newry (IE); Alain Houssais, Andilly (FR); Laurent Granseigne, Courbevoie (FR)

(73) Assignee: OLAER INDUSTRIES, Colombes (FR)

(21) Appl. No.: 14/003,691

(22) PCT Filed: Mar. 7, 2012
(86) PCT No.: PCT/FR12/50477

§ 371 Date: Nov. 8, 2013

(30) Foreign Application Priority Data
Mar. 9, 2011 (FR) 1151934

(51) Int. Cl. F17D 1/00

(52) U.S. Cl. CPC F17D 1/00
USPC 137/154

(57) ABSTRACT

The invention relates to the automatic reloading of the gas space of a hydropneumatic accumulator.

A means (20) for readjusting the load of the gas space (13) comprising a pressurized gas source (22) connected via an air system (24) to a loading valve (17) and a reinjection valve (26) controlled by a unit (27) for calculating a cycle for reinjecting gas into the gas space.

The invention relates to any equipment including one or several hydropneumatic accumulators and more particularly relates to an enhancement allowing said or each accumulator to be maintained in an optimum operating condition automatically, all along its lifetime. The invention notably applies to any equipment equipped with one or several hydropneumatic accumulators located in an environment with limited and/or hazardous access and/or not tolerating frequent interventions because for example of a high duty cycle and/or a prohibitive cost in maintenance.

A hydropneumatic accumulator consists of a rigid container in which two compartments are defined: one compartment filled with pressurized gas commonly called <<gas space>> and a compartment filled with liquid, commonly called <<liquid space>>. A separator with a flexible membrane forms a common deformable wall between both compartments.

The gas space includes a valve located at a corresponding end of the rigid container, through which a certain amount of pressurized gas may be injected and confined therein. This load of the gas space determines a certain operating range of the accumulator.

The applications are numerous. Among the latter, mention may be made of storage of <<anti-pulsation>> energy for absorbing peaks of pressure. Mention may also be made of braking assistance notably in a landing gear or on the contrary recovering energy such as for example in a truck wherein energy is recovered during a braking phase and restored during resumption of acceleration. Another field of application more particularly concerned by the invention is that of wind turbines. Such accumulators are used for feathering the blades of the wind turbine in the case of an emergency stop. In this case, the accumulators are installed in the rotary portion of the wind turbine, i.e. in a location which is particularly difficult to access.

The quality of the valves and of the permeation levels of the constitutive materials of a separator with a flexible membrane in principle allow the load of the latter to be maintained for quite a long period of time. However, it is not possible to completely avoid any small gas leaks and therefore, in the long run, a drop in the efficiency of the accumulator. This is why it is necessary to reload the gas space from time to time. To do this, connecting a pressurized gas source to the valve is known, for example by making available to the maintenance personnel, a mobile tank containing pressurized gas.

Among the applications mentioned above, there are those for which this <<manual>> reloading becomes a delicate, or even highly restrictive and/or hazardous operation.

With the invention, it is possible to solve this problem by providing a possibility of automatically loading the gas space.

More particularly, the invention relates to equipment including at least one hydropneumatic accumulator comprising a liquid space and a preloaded gas space, filled with gas at a pressure above a selected minimum value, characterized in that it comprises means for successive readjustment of the load of said gas space when the pressure of said load falls below the selected minimum value, comprising a pressurized gas source connected via an air system with a valve for loading said gas space, said air system including at least one reinjection solenoid valve with two positions, of the normally closed type, controlled by a unit for calculating successive cycles for reinjecting gas into the gas space, in that said calculation unit receives at least one signal representative of the hydraulic pressure prevailing in the liquid space or of the hydraulic power delivered by the latter and in that a control output of said calculation unit controls the successive opening and closing cycles of said reinjection solenoid valve by generating successive cycles for readjusting the load of said gas space every time its pressure falls below said selected minimum value.

In the air system and more particularly between the pressurized gas source and the reinjection valve(s), a reducing valve controlling the pressure of the gas delivered by the pressurized gas source, an adjustable nozzle (for adjusting the loading time) and an anti-return valve may be found. Preferably, these elements are connected in series and in this order.

According to certain embodiments, a flowmeter may be inserted into the air system, for determining an amount of reinjected gas during an aforementioned reinjection cycle. This flowmeter includes a signal output connected to the calculation unit, which is designed for determining the amount of reinjected gas from continuous measurement of the flow rate.

According to another possibility, the calculation unit includes a trigger input capable of receiving a signal representative of a readjustment order of the load of the gas space.

According to a possible embodiment, a pressure sensor is provided for measuring the pressure prevailing in the gas space, the output of which is connected to a data input of said calculation unit, for determining said amount of gas to be reinjected. In other words, gas is reinjected during a reinjection cycle, until the pressure prevailing in the gas space again reaches a desired value.

The equipment may also be characterized in that it includes a temperature sensor for measuring the temperature of the gas of said gas space, the output of which is connected to a data input of said calculation unit, for determining said amount of gas to be reinjected.

As this will be seen later on, the measurement of the temperature of the gas is involved as a correction value for determining the value of the pressure in the gas space for which reinjection is stopped.

According to another alternative, the equipment includes several accumulators or groups of accumulators and corresponding reinjection valves. The air system is connected to all the reinjection valves and the calculation unit includes respective control outputs connected for independently driving said reinjection valves. Thus, a reinjection cycle may only concern at a given moment a single accumulator or groups of accumulators, in spite of a single pressurized gas source and a common air system.

Optionally, such a group of accumulators associated with a same reinjection valve consists of several accumulators connected in parallel.

According to another advantageous feature, the equipment further includes a purging valve of the normally open type connected to said or each aforementioned loading valve and controlled upon closing by the calculation means during an aforementioned reinjection cycle.

According to an alternative, this purging valve may be unique. In this case, it is connected to the aforementioned air system, directly upstream from the reinjection valve(s). It is also controlled upon closing during a reinjection cycle.

Advantageously, said pressurized gas source includes at least one tank of compressed gas. This tank will preferably be placed in an accessible location so as to be easily replaced. The pressure of the gas in such a tank is greater than the maximum pressure for preloading the hydropneumatic accumulator(s).

The invention will be better understood and other features thereof will become more clearly apparent in the light of the description which follows of several embodiments of equipment according to its principle, only given as an example and made with reference to the appended drawings, wherein:

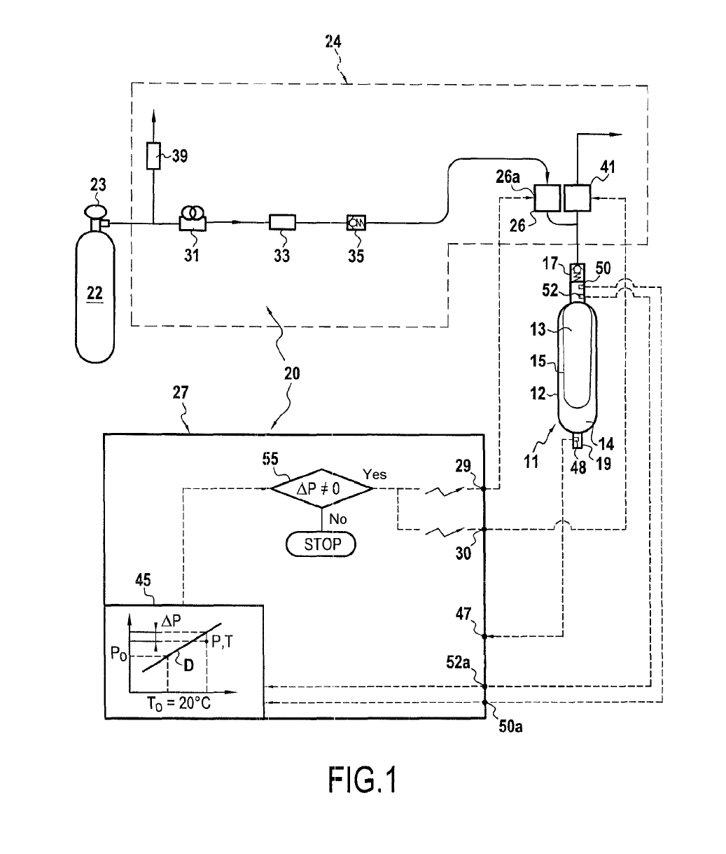

FIG. 1 is a block diagram of a first possible embodiment of the equipment according to the invention;

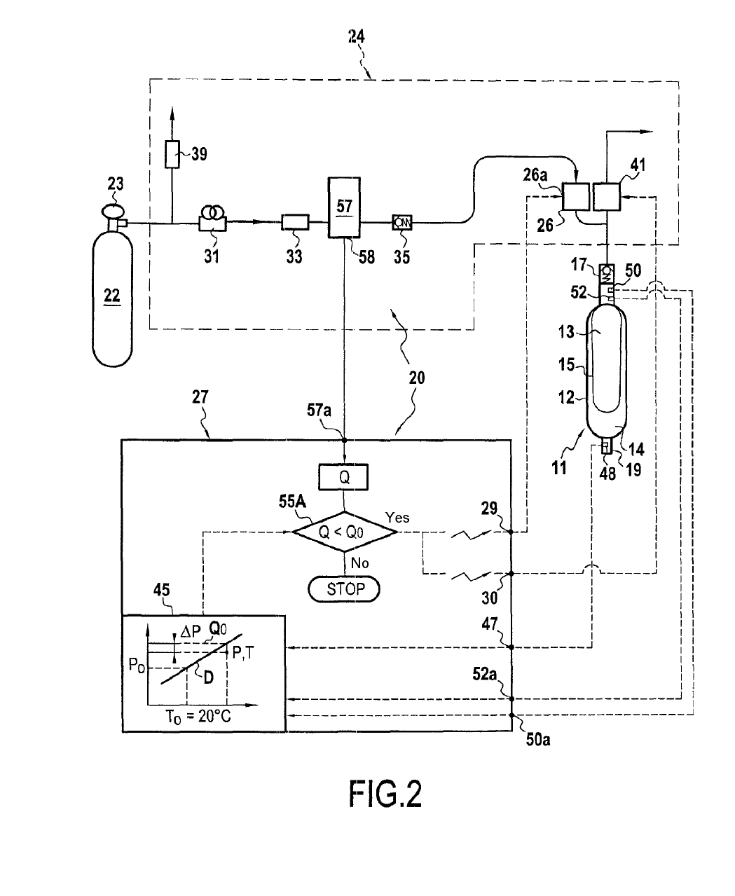

FIG. 2 is a similar block diagram illustrating one alternative;

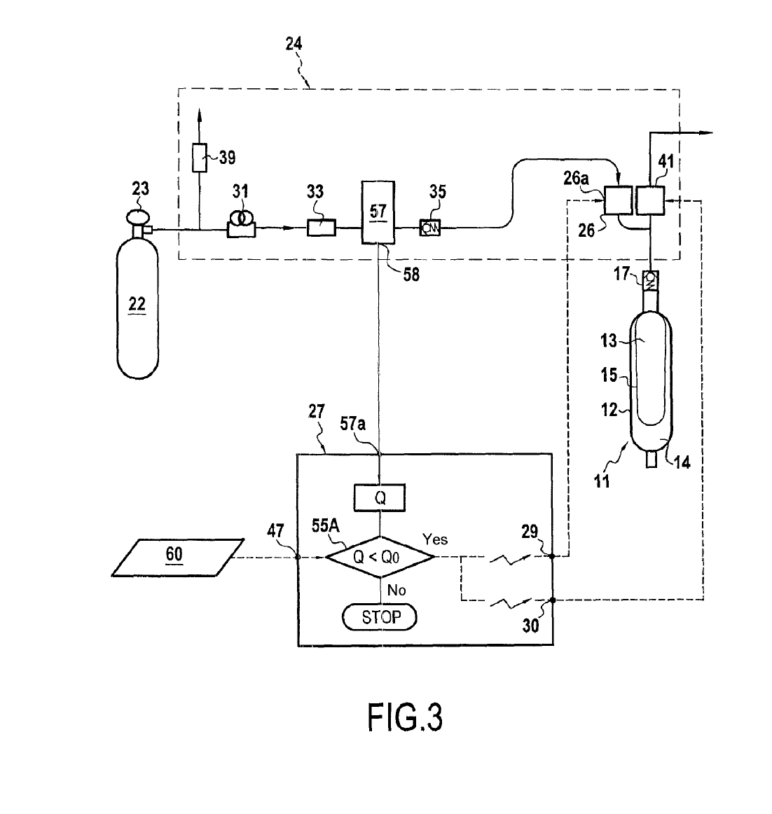

FIG. 3 is a block diagram illustrating another embodiment of the equipment;

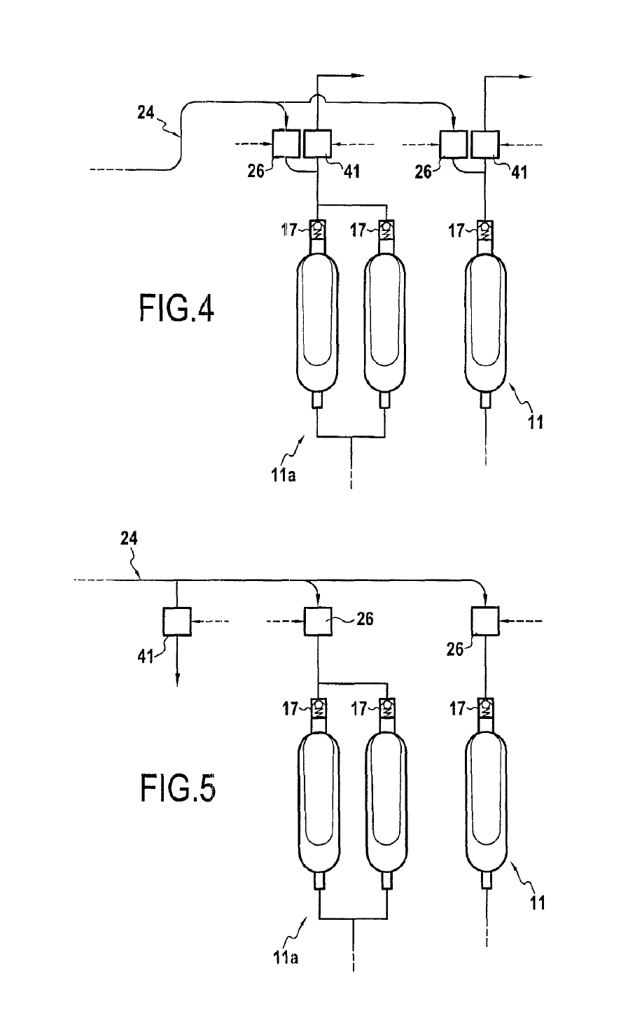

FIG. 4 is a partial block diagram illustrating a possibility of extension of the equipment; and

FIG. 5 is a view similar to FIG. 4, illustrating an alternative.

The equipment illustrated in FIG. 1 includes at least one hydropneumatic accumulator 11 conventionally comprising a rigid container 12 in which a gas space 13 and a liquid space 14 are defined. Both of these spaces of variable volumes share the internal volume of the container 12. They include a common wall formed by a separator with a flexible membrane 15. A predetermined amount of pressurized gas is confined in the gas space. A loading valve 17 communicates with the gas space and allows the loading of an intended amount of gas into the latter. In principle the gas is therefore found confined in said gas space. The liquid space includes an outlet 19 connected to a hydraulic circuit of use, not shown.

The equipment includes means 20 for readjusting the load of the gas space, connected to the loading valve 17. These readjustment means include a pressurized gas source 22 consisting here of a pressurized gas tank, an air system 24 notably including a controlled reinjection valve 26 of the normally closed type, and a unit 27 for calculating a cycle for reinjecting gas into the gas space. Said calculation unit 27 is provided for controlling the valve 26. According to a preferred example, the valve 26 is a solenoid valve, the electric signal input 26a of which is connected to a specific control output 29 of the calculation unit 27.

The outlet of the pressurized gas source 22 is equipped with a manually actuated isolating valve 23. The air system 24 extends between this valve 23 and the loading valve 17. It comprises, in series from the insulating valve 23, a reducing valve 31, an adjustable nozzle 33 and an anti-return valve 35. The reducing valve allows control of the pressure of the gas delivered by the pressurized gas source; the nozzle allows adjustment of the loading time. The pressurized gas source 22 is a simple tank of compressed gas here, which may easily be changed.

The outlet of the anti-return valve 35 is connected to the pneumatic inlet of the valve 26. The pneumatic outlet of the valve 26 is connected to the loading valve 17.

A safety valve 39, for venting, is connected in one point between the insulating valve 23 and the reducing valve 31.

A purging valve 41, here advantageously a solenoid valve, of the normally open type, is connected to said or each aforementioned loading valve 17 and controlled upon closing by the calculation unit 27. The solenoid valve 41 is connected so as to be driven by an output 30 of the calculation unit. It is driven upon closing at the beginning of a reinjection cycle.

The calculation unit 27 conventionally includes a microprocessor and electronic circuits capable of elaborating electric control signals for the solenoid valves 26 and 41, notably for receiving and processing signals stemming from various sensors, in order to allow the elaboration of electric control signals. This calculation unit will not be described in detail.

The application of the calculation unit 27 triggers a cycle for reinjecting gas into the gas space. To do this, it is driven, for starting this cycle and in the example of FIG. 1, by a signal representative of the hydraulic pressure prevailing in the liquid space 14. Thus, according to the example, a cycle triggering input 47 is connected to the output of a pressure sensor 48 of the liquid space. When this pressure reaches a low threshold, the calculation unit 27 transmits driving signals to the outputs 30 and 29 for successively closing the solenoid valve 41 and opening the solenoid valve 26, respectively.

The calculation unit 27 notably includes a compensation circuit 45 giving the possibility of adapting the amount of reinjected gas depending on the pressure and on the temperature of the gas (as compared with reference values) contained in said gas space, by means of pressure sensors 50 and temperature sensors 52, placed in contact with the gas of said gas space downstream from the valve 17. More specifically, the pressure sensor 50 measures the pressure prevailing in the gas space and its output is connected to a data input 50a of said calculation unit 27 for determining the amount of gas to be reinjected. Also, the temperature sensor 52 gives the possibility of measuring the temperature of the gas in the gas space and its output is connected to a data input 52a of said calculation unit for determining the amount of gas to be reinjected.

The compensation circuit 45 contains in memory the normal variations of the pressure P according to the temperature T in the gas space, by assuming that the latter is at its predetermined rated load depending on the characteristics of the equipment where the accumulator 11 is put to use. In FIG. 1, these variations are schematized by a straight line D.

If the input 47 receives an order for triggering the reinjection cycle elaborated from the sensor 48, the compensation circuit 45 receives from the sensors 50 and 52, representative information of the actual pressure and temperature in the gas space. This allows determination of a point (P, T) shifted from the straight line D, from which results the determination of a value ΔP, to be corrected. This value is loaded in a suitable piece of software which repeatedly carries out a test 55 on the value of ΔP, in order to elaborate driving signals which are sent to the outputs 29 and 30. More specifically, as long as the test ΔP≠0 is positive, the valve 26 is maintained open and the valve 41 is maintained closed, which allows continuous reloading of the gas space with gas from the pressurized gas source. When the test 55 becomes negative i.e. ΔP=0, the driving signals disappear and the solenoid valve 26 closes while the solenoid valve 41 opens putting the inlet of the valve 17 in contact with the atmosphere.

While the cycle for reinjecting the pressurized gas is delivered by the gas source 22 (the isolation valve 23 being open) the safety valve 39 remains closed. This gas flows under the control of the reducing valve 31 and of the adjustable nozzle 33. It crosses the anti-return valve 35 and the solenoid valves 26 for reloading the gas space 13 by forcing the valve 17 until the value ΔP determined by the calculation unit 27 (more specifically the compensation circuit 45) is brought back to zero.

In FIG. 2 illustrating an alternative, the elements similar to those described with reference to FIG. 1 bear the same numerical references and will not be described again.

This alternative is characterized in that it includes a flowmeter 57 inserted into the air system. The flowmeter includes a signal output connected to the calculation unit for determining an amount of reinjected gas during an aforementioned reinjection cycle.

The calculation unit 27 is globally similar to that of FIG. 1 but the compensation circuit is provided for inferring, notably from the value ΔP acquired like earlier, a value Q₀ representative of the amount of gas to be reinjected for reloading the gas space 13. The amount of reinjected gas Q is determined by the calculation unit 27 from the flow rate information applied to a data input 57a connected to the signal output 58 of the flowmeter 57. A suitable piece of software repeatedly carries out a test 55A elaborating driving signals available on the outputs 29 and 30. This test compares the value Q of the amount of gas introduced since the beginning of the reinjection cycle in the gas space (a value inferred from the flowmeter 57) with the value Q₀ determined by the compensation circuit 45. The order for triggering the reinjection cycle is like in the previous example, elaborated from a measurement (sensor 48) of pressure of the liquid space.

In the example of FIG. 3, the essential elements of the equipment of FIG. 2 are again found, notably the flowmeter 57 inserted into the air system 24 by means of which the calculation unit may determine in real time the amount of gas Q reinjected into the gas space at any moment of the reinjection cycle. This cycle begins and ends with the actuation of the solenoid valves 26, 41 like in the two previous embodiments.

However, in this example, the cycle is not triggered by the detection of insufficient pressure in the liquid space but by the dedicated electronic assembly 60 triggered by a representative signal of the hydraulic power delivered to the equipment to which the hydropneumatic accumulator 11 is connected. The design of this electronic assembly depends on the type of relevant equipment and is within the reach of one skilled in the art. If the measured hydraulic power reaches a certain low threshold, the dedicated electronic assembly 60 elaborates a signal for triggering a cycle, applied to the triggering input 47 which drives the calculation unit 27.

This may be simplified by determining a priori and once and for all an amount of gas Q₀ to be reinjected into each reinjection cycle. In this case, the circuit 45 may be suppressed as well as the sensors 50, 52 and of course the sensor 48, the cycles being activated by the dedicated electronic assembly 60.

Of course, the type of triggering control described in FIG. 3 may also be adapted to the equipment of FIG. 1, without any flowmeter, by using the circuit 45 and the sensors 50, 52, i.e. by controlling the reinjected gas by cancelling out the value ΔP.

In FIG. 4, equipment provided with several accumulators 11 or groups of accumulators 11a associated with corresponding reinjection valves is illustrated. As illustrated, a group of accumulators 11a, associated with a same reinjection valve 26 consists of several accumulators connected in parallel.

The air system 24 is connected to all the reinjection valves 26 while the calculation unit not shown includes respective control outputs connected for independently driving said reinjection valves.

In the example of FIG. 4, each accumulator 11 or group of accumulators 11a is associated with a specific purging valve 41 of the normally open type. Each valve is directly connected to each loading valve 17 and is controlled upon closing by the calculation unit during a reinjection cycle corresponding to the relevant accumulator or group of accumulators. Each valve 41 is controlled by a specific output of the calculation unit.

On the contrary, in the embodiment of FIG. 5, the purging valve 41 is unique. This valve normally open is connected to the air system 24 directly upstream from said or each reinjection valve. According to the example, it is therefore connected downstream from the anti-return valve 35. It is controlled upon closing during a reinjection cycle.

1. Equipment including at least one hydropneumatic accumulator comprising a liquid space and a preloaded gas space, filled with a gas under a pressure greater than a selected minimum value,
including means for successive readjustments of the load of said gas space when the pressure of said load falls below the selected minimum value, comprising a pressurized gas source connected via an air system to a loading valve of said gas space, said air system including at least one reinjection solenoid valve with two positions, of the normally closed type, controlled by a calculation unit for successive cycles of reinjection of gas into said gas space,
wherein said calculation unit receives at least one representative signal of the hydraulic pressure prevailing in the liquid space or of the hydraulic power delivered by the latter and
wherein a control output of said calculation unit controls the successive cycles for opening and closing the said reinjection solenoid valve by generating successive cycles for readjusting the load of said gas space every time its pressure falls below the said selected minimum value.

2. The equipment according to claim 1, including a reducing valve inserted into said air system.

3. The equipment according to claim 1, including an adjustable nozzle inserted into said air system.

4. The equipment according to claim 1, includes including an anti-return valve inserted into said air system.

5. The equipment according to claim 1,
wherein said air system between the pressurized gas source on the one hand and the reinjection solenoid valve(s) on the other hand, are inserted in series: a reducing valve controlling the pressure of the gas delivered by said pressurized gas source, an adjustable nozzle and an anti-return valve.

6. The equipment according to claim 1, includes including a flowmeter inserted into said air system, said flowmeter including a signal output connected to said calculation unit, for determining a reinjected amount of gas during an aforementioned reinjection cycle.

7. The equipment according to claim 1, wherein said calculation unit includes a triggering input able to receive a representative signal of an order for readjusting the load of said gas space.

8. The equipment according to claim 1, including a pressure sensor for measuring the pressure prevailing in said gas space, the output of which is connected to a data input of said calculation unit, for determining said amount of gas to be reinjected.

9. The equipment according to claim 1, including a temperature sensor for measuring the temperature of the gas of said gas space, the output of which is connected to a data input of said calculation unit, for determining said amount of gas to be reinjected.

10. The equipment according to claim 1, includes including several accumulators or groups of accumulators and corresponding reinjection valves,
wherein said air system is connected to all the reinjection valves and
wherein said calculation unit includes respective control outputs connected for independently driving said reinjection valves.

11. The equipment according to claim 10, wherein such a group of accumulators, associated with a same reinjection valve, consists of several accumulators connected in parallel.

12. The equipment according to claim 1, further including a purging valve of the normally open type; connected to said or to each aforementioned loading valve and controlled upon closing by the calculation unit during an aforementioned reinjection cycle.

13. The equipment according to claim 1, further including a single purging valve of the normally open type connected to said air system directly upstream from said or each reinjection valve and controlled upon closing during an aforementioned reinjection cycle.

14. The equipment according to claim 1, wherein said pressurized gas source includes at least one tank of compressed gas, the pressure of which is greater than that of the maximum preloading pressure of the hydropneumatic accumulator(s).
